(19) United States
(12) Patent Application Publication
(10) Pub. No.: US 2018/0114175 A1
(43) Pub. Date: Apr. 26, 2018

(54) ALGORITHMIC ESCALATION OF DATA ERRORS IN BIG DATA MANAGEMENT SYSTEMS

(71) Applicant: Google Inc., Mountain View, CA (US)

(72) Inventors: Long Fei, Campbell, CA (US); Behrooz Khorashadi, Mountain View, CA (US); Robbie Alan Haertel, San Jose, CA (US)

(21) Appl. No.: 14/561,654

(22) Filed: Dec. 5, 2014

(51) Int. Cl. G06Q 10/06; G06F 17/30

(52) U.S. Cl. CPC G06Q 10/063114; G06F 17/30342

(57) ABSTRACT

Technology for addressing errors in a data management system. An aspect of the technology involves automatically tracking reassignments of errors from entities initially responsible for correcting the errors to entities newly responsible for correcting the errors, such that each time an assignment of an error is changed from a first entity to a second entity a record is automatically generated to associate the error with the second entity, and generating, based on automated analysis of the tracking of reassignments, an index comprising a plurality of error types and, for each error type, an entity assigned to correct the error type, wherein at least one error type that was assigned to an initially responsible entity is automatically reassigned to a newly responsible entity based on the automated analysis.

### BACKGROUND

Unless otherwise indicated herein, the materials described in this section are not prior art to the claims in this application and are not admitted to be prior art by inclusion in this section.

The use of computers and computer software has become increasingly prevalent in numerous aspects of modern life. One of the common uses of computers is in data management. The number of ways in which computers and software can be used to manage data is legion. Nevertheless, the management of data in a given context is generally said to be handled by a “data management system.”

Various errors can be present in data in a data management system. For example, data may be corrupted, data may be stored in violation of a privacy policy, and data may be redundantly stored when redundant storage is unwanted. A key step to addressing such data errors is to properly escalate the errors. Escalation of a data error typically involves determining the severity of the error, and finding the entity that creates the erroneous data or that maintains the application which produces the data. In some cases the entity is a single person. In other cases, the entity is a team of people or a non-human entity.

### BRIEF SUMMARY

It has been recognized that the advent of ubiquitous computing has given rise to big data management systems, and an attendant need to efficiently escalate a potentially large number of errors in big data management systems.

It has been further recognized that in big data management systems, the process of escalating data errors is more challenging due to a number of factors. One factor is the volume of data. That is, a large volume of data can lead to a large number of data errors having to be managed at any one time. For example, there can be thousands of data errors in thousands of data sets managed by a system at any given time. Another factor that makes error escalation more difficult is denormalization. In denormalized systems multiple applications may share a dataset, in which case there is no single dedicated owner to whom errors in the dataset can be escalated. Still another factor is the scale of the community served. For example, a big data management system may serve a community that consists of tens of thousands of active developers. In such a large community people are constantly moving from project to project, and team structures change all the time, thereby making it difficult to readily identify a project or team appropriate for a given error. Yet another factor is diversity of product knowledge. A big data management system may serve a large number of products/projects, and in such context it is infeasible for any individual/team to have enough technical, product, and organizational knowledge to determine the severity of all data errors in the context of corresponding products/projects and effectively track who is responsible for a given data error.

The present technology has been developed in view of the challenges associated with escalating errors in big data management systems. In one aspect, the technology is intended to improve efficiency in the escalation of errors by automatic and continuous refinement of the error escalation process.

In one implementation of the present technology, an index is created in which error types are cross-referenced to entities responsible for error correction. For example, one type of error in the index, that is a “first error type,” may be defined as errors that occur in a first dataset, and a second type of error in the index, that is a “second error type,” may be defined as errors that occur in a second dataset, and the index may indicate that all errors of the first type are handled by a first entity and that all errors of the second type are handled by a second entity.

The index is refined by tracking reassignment of errors to entities so that when an error assignment is changed from a first entity to a second entity a record is automatically generated to associate the error with the second entity. By employing an algorithm to analyze such records, and refine the index based on such records, the system is made adaptive. That is, for example, when the index references errors of a first type to a first entity, but analysis of error reassignments shows that errors of the first type are being reassigned to a second entity, the index is revised to refer errors of the first type to the second entity.

Handling data errors in this manner provides many advantages. Among the advantages are decentralization and scalability. The process of assigning error types to entities doesn't need to be controlled or coordinated by a team or an individual, the assignment of error types to entities is crowdsourced.

Several embodiments of the present technology will be discussed in detail below.

### BRIEF DESCRIPTION OF THE DRAWINGS

FIG. 1 is a diagram of a network system.

FIG. 2 is a diagram showing how the assignment of errors is refined over time.

FIG. 3 is a flow chart depicting a process of assigning errors to entities and updating an index for assigning errors to entities.

### DETAILED DESCRIPTION

Examples of methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

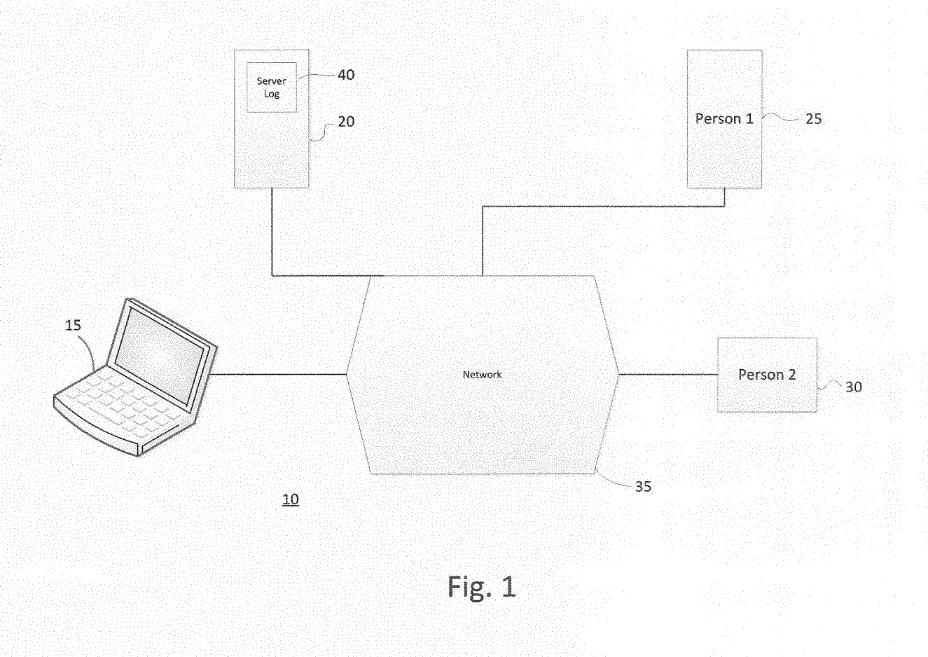

FIG. 1 is a diagram of a network system 10 according to the present technology. As can be seen from the figure, system 10 may include a user device 15, servers 20, 25, and 30, and a network 35. In an example of an embodiment, the user device may take the form of a desktop computer, a laptop computer, a notebook computer, a tablet computer, a mobile phone, but is not limited to such forms. Further, network 35 may be the Internet, and server 20 may be a web server that stores a server log 40 which maintains a history of web page requests made over the network through user device 15. In such example, servers 25 and 30 may be associated with respective persons who can remedy errors in the data stored in server log 40. That is, logging errors present in server log 40 may be escalated to Person 1 at server 20 or to Person 2 at server 30, or to both Person 1 and Person 2.

Regarding the user device 15 and servers 20, 25, and 30, it should be noted that each such elements are not limited to a single device or a single location. That is, each such element may take the form of several devices, and those devices may or may not be geographically dispersed. Each of the elements is depicted as singular only for the sake of brevity of description, and should not be limited to being embodied by a single device or at a single location. For example, sever 20 may be implemented in the cloud, and as such, may be made up of software that runs on a multiple of platforms.

Regarding the server log 40, it should be noted that such server log is used by way of example. Indeed, the data may be stored in any type of device capable of communicating with the network. These include, but are not limited to, a general purpose computer, a personal computer, a server, a cloud service, a mobile device such as a smart phone or a tablet, a wearable device such as a watch or glasses, any device in which a processor or computer is encapsulated such as a thermostat, a smoke detector, or other environmental sensor or controller, or a personal sensor such as for health monitoring or alerting, a car or other vehicle such as a self-driving car or a drone or other airborne vehicle. Moreover, the data may be stored via a platform as a service, or via an infrastructure as a service.

In addition, the following is noted regarding network 35 and servers 25 and 30. Network 35 is not limited to a single network, and servers 25 and 30 are merely illustrative. Network 35 may include a multiple of inter-connected networks, and any number of servers or other types of devices may be recipients of escalated errors.

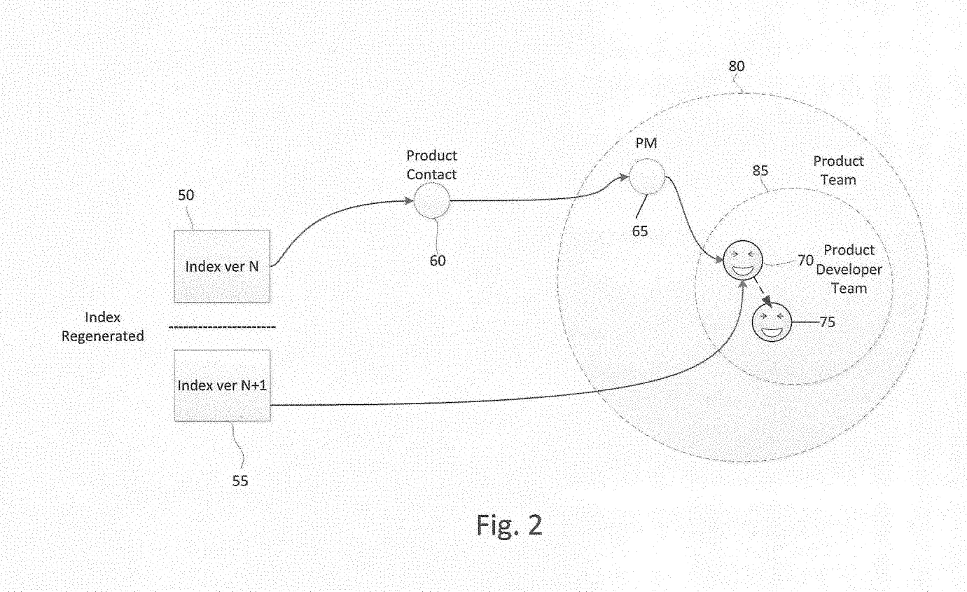

Referring now to FIG. 2, there is shown a diagram depicting one way in which the assignment of errors may be refined over time. The diagram of FIG. 2 will be discussed in the context of a FIG. 1 implementation with the understanding that FIG. 2 is not limited to a FIG. 1 implementation.

FIG. 2 concerns the updating of an Index. The Index is updated from Index ver N 50 to Index ver N+1 55, N being an integer greater than or equal to zero. The Index may take the form of a database that cross-references data error types to entities, such that each data error type is associated with an entity to which the data error type is assigned for handling. One of the ways in which data error types may be classified is by datasets. That is, the data error type for an error in data that is part of dataset x may be said to be a data error of the type “error in data set x.” Moreover, a dataset may be identified by a dataset ID, and the dataset ID may take the form of a data path, a system name, a token, a bit sequence, an arbitrary name, a checksum, a hash value, or any other suitable form, as long as the dataset IDs are unique to their respective error types. In the case of the dataset ID being in the form of a data path such path may be, for instance, a storage path, a logical path, or a symbolic path. One example of a suitable data path is a uniform resource identifier (URI). Regardless of the form of dataset IDs, such ID's may be used to classify error types, and may be cross-referenced to entities in an Index.

The entities assigned to respective data error types may take many forms. For example, an entity may be a person, a multiple of persons, software, a computer, a multiple of computers, or a combination of any of these. In the example of FIG. 2, six entities are shown, product contact 60, product manager (PM) 65, person 70, person 75, product team 80, and product developer team 85.

In one embodiment, when an error is detected the data error type is determined and Index ver N 50 is consulted by, for example server 20, to determine an entity that is assigned to handle errors of the determined type. As shown in FIG. 2, product contact 60 is determined to be the entity for handling the error type, and therefore the error is assigned to product contact 60 through, for example, server 25.

Product contact 60 may be a person who is designated as the primary contact for a software product or service, such as a web-based retailer, or a general manager that oversees several related products or services. The error that is assigned to product contact 60 may be a privacy violation error. That is, the error may be that of gathering and storing information about a purchaser when gathering and storage of such information is prohibited by law. Alternatively, the data error may be one of data corruption, unwanted redundancy, or any other form of data error.

In any event, the data error that has been assigned to product contact 60 may be reassigned. In the case of FIG. 2, product contact 60 reassigns the error to product manager 65 through, for example, server 30. Product manager 65, in turn, reassigns the error to person 70 through, for example, server 30. Person 70 may then handle the error, or as an option, reassign the error to person 75 through, for example, server 30. The person who is finally assigned the error handles the error by, for example, patching the code that caused the error. Other actions that may make up handling the data error include, but are not limited to, correcting the data, determining whether or not hardware caused the error, and fixing broken hardware that caused the error.

When errors of the type discussed in connection with FIG. 2 are repeatedly reassigned to person 70, the Index may be modified to cross-reference such error type to person 70 rather than product contact 60. The modified Index is depicted in the figure as Index ver N+1 55. As can be seen, following modification of the index, when an error of the type discussed in connection with FIG. 2 is detected, such error is assigned directly to person 70 rather than to product contact 60.

There are numerous ways to determine when an index should be modified to change a responsible entity for a given error type. For example, the ways to determine when an index should be updated include, but are not limited to, updating the index each time an error is reassigned, updating the index periodically (e.g. every N days), updating the index based on the accuracy of recently assigned errors (e.g. update only if the rate of errors reassigned rises above a threshold), and updating the index based on personal discretion (e.g. a person makes a decision to update based on experience and/or observation). In one implementation, an Index is updated periodically and changes are made based on the number of times, within the period, in which an error of a given type is reassigned to a particular entity. For example, when the number of reassignments of errors of a given type to a particular entity is greater than a threshold value, the Index is changed to associate the given type with the particular entity. In another implementation, an entity is a union of people assigned a given error type, and each time an error of the given type is reassigned to a person who is not part of the union, the person is added to the union.

Referring back to FIG. 2, it should be noted that in lieu of reassigning the error to product manager 65, the product contact 60 may more generally reassign the error to product team 80. Product team 80 may then decide to reassign the error to product manager 65, or to some other member of the product team. Similarly, in lieu of reassigning the error to person 70, the product manager 65 may more generally reassign the error to product developer team 85. Product developer team 85 may then decide to reassign the error to person 70, or to some other member of the product developer team. Incidentally, it should be noted that the product developer team 85 may be a team within product team 80.

Regarding the Index of FIG. 2, it should be noted that the initial version may be designated by Index ver N 50, where N=0. The initial version of the Index may be in existence, in the same form as Index ver N 50 or in some other form, and the present technology may be used to refine such initial version. Or, the present technology may include the creation of an initial version of the Index. The initial version could be created in a number of ways. One way to create the initial version is to aggregate information apart from the reassignment of errors. For example, the initial version could be created by entering data from an existing registry of maintenance owners of data or applications that produce the data. Other ways to create the initial version include, but are not limited to, creating the initial version based on a company organization chart, with general managers and/or directors as initial entities to which error types are cross-referenced, based on a company product profile, with product managers as initial entities, based on a codebase, with development owners as initial entities, and based on a survey of users, with the users declaring responsibility for respective datasets and serving as initial entities for the respective error types.

Further, regarding the Index in general, it should be noted that the Index may include indications of error severities. In one implementation, an error type is associated with an error severity, and the Index cross-references the error type to both an indication of severity and an entity responsible for correcting errors of the error type. In such implementation, for a given error the entity to which the error is assigned, or any entity to which the error is reassigned, may change the severity of the error. Such severity changes are noted and the Index may be revised on the basis of such changes.

Revising the Index based on severity changes may be accomplished in manners similar to those applicable to revising the index based on reassignments of responsible entities. For example, the ways to determine when an index should be revised to change a severity for a given error type include, but are not limited to, updating the index each time a severity is changed, updating the index periodically (e.g. every N days), updating the index based on the accuracy of severity for recently assigned errors (e.g. update only if the rate of severity changes rises above a threshold), and updating the index based on personal discretion (e.g. a person makes a decision to update based on experience and/or observation). In one implementation, an Index is updated periodically and changes are made based on the number of times, within the period, in which the severity is changed for errors of a given type. For example, when the number of severity changes for errors of a given type is greater than a threshold value, the Index is changed to associate the given type with a new severity. The new severity may be, for instance, the most common severity to which the severity was changed for the error type during the period. In another implementation, a given error type is associated with a collection of severities that have been assigned to the error type, and each time an error of the type is assigned a new severity that is not part of the collection, the severity is added to the collection.

In another implementation, a given error type may be associated with more than one error severity. That is, an error of a given type and a first severity may be cross-referenced to a first entity, while an error of the same type and a second severity is cross-referenced to a second entity. Thus, when an error of the given type and the first severity is assigned to the first entity, and the first entity changes the severity of the error to the second severity, the change in severity acts as a reassignment of the error of the given type and first severity to the second entity. Similarly, when an error of the given type and the first severity is reassigned to an entity, and that entity changes the severity of the error to the second severity, the change in severity acts as a reassignment of the error of the given type and first severity to the second entity.

It should be noted that an index may be revised based on both severity changes and reassignments of responsible entities, or based on only one of severity changes and reassignments of responsible entities. Further, when an index is revised based on both severity changes and reassignments of responsible entities, such types of revisions may be performed concurrently or at different times. Still further, when an index is revised based on both severity changes and reassignments of responsible entities, the manners in which such types of revisions are performed may differ, regardless of the timing of such types of revisions.

In addition, it should be noted that error severities may be automatically predicted. For example, an error severity could be predicted using machine learning based on such factors as the error type, the source of the error, the team to which the error is assigned or reassigned, etc. Thus, in one implementation an error of a given type is assigned to an entity based on an index by cross-referencing the error type to the entity, and is then assigned a predicted severity. In another implementation an error of a given type is assigned a predicted severity, and then an index is referenced to determine a responsible entity for the error of the given type and the predicted severity.

Still further, it should be noted that the embodiments concerning error severities are equally applicable to error priorities. That is, additional embodiments of the present technology include those which are described in this disclosure but are modified by substituting error priorities for error severities.

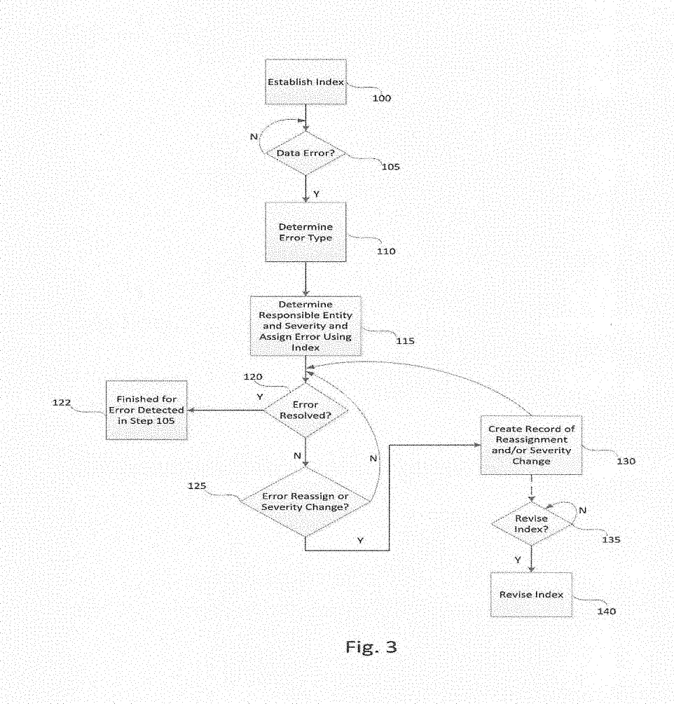

Referring now to FIG. 3, there is shown a flow chart depicting a process of assigning errors to entities and updating an Index for assigning errors to entities. As shown in the figure, the initial step is to establish an index (Step 100). This step can be performed in a number of ways. One way is to electronically aggregate data from a variety of sources, such as an existing registry of maintenance owners of data or applications that produce the data. The next step is to monitor for data errors (Step 105). This step is continual. However when an error is detected, steps 110-130 are performed.

When an error is detected, the error type is determined (Step 110). Next the Index is referenced to determine a responsible entity and a severity for errors of the determined type, and the error is assigned to the responsible entity (Step 115). It is possible that the Index is referenced to determine only a responsible entity rather than a responsible entity and a severity, nevertheless both a responsible entity and a severity are contemplated in the example of FIG. 3.

Next, a determination is made as to whether or not the error has been resolved (Step 120). If the error has been resolved, the process is finished with respect to the detected error (Step 122). If the error has not been resolved, the process monitors for reassignment of the error and severity change for the error (Step 125). If there is no reassignment or severity change, the process returns to the step of monitoring for error resolution (Step 120), and if there is a reassignment or severity change, the process creates a record of the reassignment and/or severity change (Step 130). Following the creation of one or more records to document reassignment and/or severity change, the process again returns to monitoring for error resolution (Step 120).

The creation of one or more records of reassignment and/or severity change may be used to trigger revision of the Index. Accordingly, following the creation of such record(s) (Step 130) the process may check to see if the Index should be revised (Step 135). If the Index should be revised, revision of the Index is performed (Step 140). For example, an Index revision may be triggered each time an error is reassigned. However, it should be noted that numerous alternatives may be employed to determine when the Index should be revised, and that such alternatives will be apparent to one skilled in the art upon viewing the present disclosure.

In some alternative embodiments, steps 135 and 140 are independent of steps 105-130. For example, the Index may be revised periodically, in which case the “Y” branch of step 135 is followed and step 140 is performed periodically without regard to step 130. Further, the Index may be revised, the “Y” branch of step 135 being followed and step 140 being performed, whenever the rate of reassignments or severity changes exceeds a threshold or whenever a person exercises discretion to revise the Index, in each case the revision being performed without regard to step 130. In each of these alternative embodiments, any reassignment and/or severity change information recorded in step 130 is reflected in the revised Index.

The process discussed in connection with FIG. 3 may be configured according to a program stored in a computer-readable medium. That is, an aspect of the present technology provides a tangible, computer-readable storage medium that includes instructions that, when executed by a processor, cause the processor to perform the process of FIG. 3. Another aspect of the present technology provides a tangible, computer-readable storage medium that includes instructions that, when executed by a processor, cause the processor to perform processes of embodiments of the present technology other than those represented by FIG. 3.

The present technology may be configured as follows.

(1) A method for addressing errors in a data management system, including automatically tracking reassignments of errors from entities initially responsible for correcting the errors to entities newly responsible for correcting the errors, such that each time an assignment of an error is changed from a first entity to a second entity a record is automatically generated to associate the error with the second entity; and generating, based on automated analysis of the tracking of reassignments, an index comprising a plurality of error types and, for each error type, an entity assigned to correct the error type, wherein at least one error type that was assigned to an initially responsible entity is automatically reassigned to a newly responsible entity based on the automated analysis.

(2) The method according to (1), further including the step of establishing an initial index by aggregating information apart from the tracking of reassignment of errors, and wherein the step of generating includes updating the initial index based on the tracking of reassignment of errors.

(3) The method according to (1) or (2), further including tracking error severity changes such that when a severity of an error is changed from a first severity to a second severity a record is automatically generated to associate the second severity with the error, and wherein the step of generating includes generating, based on the tracking of reassignment of errors and the tracking of error severity changes, an index including a plurality of error types and, for each error type, an entity assigned to correct the error type and an error severity.

(4) The method according to any of (1) to (3), wherein at least one of the error types is associated with more than one error severity.

(5) The method according to any of (1) to (4), wherein the error types are defined by at least respective datasets in which they occur.

(6) The method according to any of (1) to (5), wherein each dataset is identified by a unique identifier including a data path.

(7) The method according to any of (1) to (6), wherein at least one of the first entity and the second entity is a person.

(8) The method according to any of (1) to (7), wherein at least one of the first entity and the second entity is non-human.

(9) The method according to any of (1) to (8), wherein the step of generating is performed periodically.

(10) A system for addressing errors in a data management system, including one or more devices to automatically track reassignments of errors from entities initially responsible for correcting the errors to entities newly responsible for correcting the errors, such that each time an assignment of an error is changed from a first entity to a second entity a record is automatically generated to associate the error with the second entity, and to generate, based on automated analysis of the tracking of reassignments, an index comprising a plurality of error types and, for each error type, an entity assigned to correct the error type, wherein at least one error type that was assigned to an initially responsible entity is automatically reassigned to a newly responsible entity based on the automated analysis.

(11) The system according to (10), wherein one or more of the devices is geographically dispersed.

(12) The system according to (10) or (11), wherein at least one of the devices includes software that runs on a multiple of platforms.

(13) The system according to any of (10) to (12), wherein the devices establish an initial index by aggregating information apart from the tracking of reassignment of errors, and generate the index by updating the initial index based on the tracking of reassignment of errors.

(14) The system according to any of (10) to (13), wherein the devices track error severity changes such that when a severity of an error is changed from a first severity to a second severity a record is automatically generated to associate the second severity with the error, and generate, based on the tracking of reassignment of errors and the tracking of error severity changes, an index including a plurality of error types and, for each error type, an entity assigned to correct the error type and an error severity.

(15) The system according to any of (10) to (14), wherein at least one of the error types is associated with more than one error severity.

(16) The system according to any of (10) to (15), wherein the error types are defined by at least respective datasets in which they occur.

(17) The system according to any of (10) to (16), wherein each dataset is identified by a unique identifier including a data path.

(18) The system according to any of (10) to (17), wherein at least one of the first entity and second entity is a person.

(19) The system according to any of (10) to (18), wherein at least one of the first entity and second entity is non-human.

(20) The system according to any of (10) to (19), wherein the devices generate the index periodically.

Although the description herein has been made with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A method for addressing errors in a data management system, comprising:
automatically tracking reassignments of errors electronically, by keeping electronic records of the reassignments, from entities initially responsible for correcting the errors to entities newly responsible for correcting the errors, such that each time an assignment of an error is changed from a first entity to a second entity an electronic record is automatically generated to associate the error with the second entity; and
generating, based on automated analysis of the records of the reassignments, an index in the form of a computer-readable database that comprises a plurality of error types and, for each error type, cross-references the error type with an entity assigned to correct the error type, wherein at least one error type that was assigned to an initially responsible entity is automatically reassigned to a newly responsible entity based on the automated analysis by automatically modifying the database to change a cross-reference for the at least one error type from the initially responsible entity to the newly responsible entity.

2. The method as recited in claim 1, further comprising the step of establishing an initial index by aggregating information apart from the tracking of reassignment of errors, and wherein the step of generating comprises updating the initial index based on the tracking of reassignment of errors.

3. The method as recited in claim 1, further comprising tracking error severity changes such that when a severity of an error is changed from a first severity to a second severity a record is automatically generated to associate the second severity with the error, and wherein the step of generating comprises generating, based on the tracking of reassignment of errors and the tracking of error severity changes, an index comprising a plurality of error types and, for each error type, an entity assigned to correct the error type and an error severity.

4. The method as recited in claim 3, wherein at least one of the error types is associated with more than one error severity.

5. The method as recited in claim 1, wherein the error types are defined by at least respective datasets in which they occur.

6. The method as recited in claim 5, wherein each dataset is identified by a unique identifier comprising a data path.

7. The method as recited in claim 1, wherein at least one of the first entity and the second entity is a person.

8. The method as recited in claim 1, wherein at least one of the first entity and the second entity is non-human.

9. The method as recited in claim 1, wherein the step of generating is performed periodically.

10. A system for addressing errors in a data management system, comprising:
one or more devices to automatically track reassignments of errors electronically, by keeping electronic records of the reassignments, from entities initially responsible for correcting the errors to entities newly responsible for correcting the errors, such that each time an assignment of an error is changed from a first entity to a second entity an electronic record is automatically generated to associate the error with the second entity, and to generate, based on automated analysis of the records of the reassignments, an index in the form of a computer-readable database comprising a plurality of error types and, for each error type, cross-references the error type with an entity assigned to correct the error type, wherein at least one error type that was assigned to an initially responsible entity is automatically reassigned to a newly responsible entity based on the automated analysis by automatically modifying the database to change a cross-reference for the at least one error type from the initially responsible entity to the newly responsible entity.

11. The system as recited in claim 10, wherein one or more of the devices is geographically dispersed.

12. The system as recited in claim 10, wherein at least one of the devices comprises software that runs on a multiple of platforms.

13. The system as recited in claim 10, wherein the devices establish an initial index by aggregating information apart from the tracking of reassignment of errors, and generate the index by updating the initial index based on the tracking of reassignment of errors.

14. The system as recited in claim 10, wherein the devices track error severity changes such that when a severity of an error is changed from a first severity to a second severity a record is automatically generated to associate the second severity with the error, and generate, based on the tracking of reassignment of errors and the tracking of error severity changes, an index comprising a plurality of error types and, for each error type, an entity assigned to correct the error type and an error severity.

15. The system as recited in claim 14, wherein at least one of the error types is associated with more than one error severity.

16. The system as recited in claim 10, wherein the error types are defined by at least respective datasets in which they occur.

17. The system as recited in claim 16, wherein each dataset is identified by a unique identifier comprising a data path.

18. The system as recited in claim 10, wherein at least one of the first entity and second entity is a person.

19. The system as recited in claim 10, wherein at least one of the first entity and second entity is non-human.

20. The system as recited in claim 10, wherein the devices generate the index periodically.

21. The method as recited in claim 1, wherein the step of generating is performed when a rate of the reassignments rises above a threshold.

22. The method as recited in claim 1, wherein the step of generating is performed periodically, and wherein at least one error type is automatically reassigned to a particular entity when the automated analysis indicates that a number of reassignments of the error type to the particular entity during a pre-determined period is greater than a threshold.

23. The system as recited in claim 10, wherein the one or more devices generate the index when a rate of the reassignments rises above a threshold.

24. The system as recited in claim 10, wherein the one or more devices generate the index periodically, and wherein at least one error type is automatically reassigned to a particular entity when the automated analysis indicates that a number of reassignments of the error type to the particular entity during a pre-determined period is greater than a threshold.
